(19) United States
(12) Patent Application Publication
(10) Pub. No.: US 2014/0006290 A1
(43) Pub. Date: Jan. 2, 2014

(54) METHOD FOR AUTHENTICATING FIRST COMMUNICATION EQUIPMENT BY MEANS OF SECOND COMMUNICATION EQUIPMENT

(71) Applicants: Cédric Hozanne, Lorgies (FR); Benoît Courouble, Hem (FR)

(72) Inventors: Cédric Hozanne, Lorgies (FR); Benoît Courouble, Hem (FR)

(73) Assignee: NATURAL SECURITY SAS, Lille (FR)

(21) Appl. No.: 13/980,597

(22) PCT Filed: Dec. 15, 2011
(86) PCT No.: PCT/FR2011/053009

§ 371 Date: Sep. 18, 2013

(30) Foreign Application Priority Data
Jan. 19, 2011 (FR) 1150415

(51) Int. Cl. G06Q 20/38; G06Q 20/40

(52) U.S. Cl. CPC G06Q 20/38215; G06Q 20/401; G06Q 20/3829
USPC 705/75

(57) ABSTRACT

The invention generally relates to the field of biometric authentication methods. The invention specifically relates to a method for authenticating first communication equipment by means of second communication equipment. Compared with the known biometric authentication methods of the prior art, the invention enables an increase to be achieved in the number of exchanges in authenticating (2) the first equipment by means of the second equipment and in opening (3) a secure communication channel between said two pieces of equipment, therefore saving time, said authentication and channel-opening operations taking place in the biometric authentication methods between, on the one hand, a detection (1) of the first equipment by the second equipment, and a biometric authentication (5) of the user and a selection of an application and an application-related transaction between the two pieces of equipment on the other hand.

The invention relates generally to the field of methods of biometric authentication. The invention relates more particularly to a method of authentication of a first communication apparatus by a second communication apparatus, the first apparatus comprising at least one storage medium suitable for storing at least:
an nth encryption certificate comprising a first public key associated with the first apparatus and a signature affixed by a certification authority that issued the encryption certificate, and
a first private key associated asymmetrically with the first public key,

the nth encryption certificate being recognized by the second apparatus.

International applications WO 2005/078647 and WO 2007/100709 describe methods of biometric authentication implementing at least one first communication apparatus and one second communication apparatus. The first communication apparatus comprises a storage means for storing data containing a biometric template, applications and contact and/or contactless communication means for data reception and transmission. The first communication apparatus also comprises processing means for operating in particular a comparison between the biometric model that it stores and a biometric sample acquired by a biometric sensor linked to the second communication apparatus and received from communication means of the second communication apparatus. If the biometric sample corresponds to the biometric model, the carrier of the first communication apparatus is authenticated by the second communication apparatus as legitimate owner of this apparatus. The second communication apparatus is then designed to complete the establishment of a transactional session with the first communication apparatus, and then select 5 an application of the first communication apparatus to be called so as to complete the transaction 6 (cf. FIG. 1). The first communication apparatus is designed to transmit to the second communication apparatus a result of the application called by the second communication apparatus.

These methods therefore envisage the transfer between the two communication apparatuses of the biometric data specific to the user. It is understood that this transfer must be carried out in a secure manner with apparatuses that have been recognized as intact and authentic.

As illustrated in FIG. 1, subsequent to a detection 1 with or without contact of the first communication apparatus by the second communication apparatus and prior to the authentication of the carrier 4 of the first communication apparatus, these methods implement two successive, distinct and independent steps:
a step of authentication 2 of the first communication apparatus by the second communication apparatus, and
a step of opening 3 of a secure communication channel between the first communication apparatus and the second communication apparatus.

These two steps are preferably carried out in the abovementioned order, so that a secure communication channel is open only with each first authenticated communication apparatus, and it should be noted that the step of opening a secure communication channel, although presented as optional, is preferably carried out.

In this context, and more particularly in the context of cash-register payment for merchandise at a point of sale, it is understood that it is advantageous to reduce the time required to carry out the transaction.

The present invention, which rests upon this original observation, proposes an applicative solution making it possible to carry out each transaction in a reduced time.

To this end, the method of authentication of a first communication apparatus by a second communication apparatus, moreover in accordance with the preamble hereinabove, is essentially such that it comprises:
a first step of transmission from the first apparatus to the second apparatus of said nth encryption certificate,
a first step of verification by the second apparatus of the signature of said nth encryption certificate,
a first step of generation by the second apparatus of a first encryption key, the latter comprising at least one part of a challenge,
a first step of encryption by the second apparatus with said first public key of the first encryption key,
a second step of transmission from the second apparatus to the first apparatus of the first encrypted encryption key,
a first step of decryption by the first apparatus with said first private key of said first encrypted encryption key,
a second step of generation by the first apparatus of a response to the challenge,
a third step of transmission from the first apparatus to the second apparatus at least of the response to the challenge, and
a second step of verification by the second apparatus of the response to the challenge.

The method thus makes it possible to combine authentication of the first apparatus by the second apparatus and opening of a secure communication channel between the first apparatus and the second apparatus while appreciably reducing the number of exchanges required, and therefore the time required, with respect to a method in which the steps of authentication of the first apparatus by the second apparatus and of opening of a secure communication channel between the first apparatus and the second apparatus are carried out in a successive, distinct and independent manner. It should be noted that the encryption key is transmitted from the second apparatus to the first apparatus in a secure manner.

According to a particular feature, the method furthermore comprises, prior to the first step of transmission from the first apparatus to the second apparatus of said nth encryption certificate, a first step of selection by the second apparatus from among a set of certificates stored on the storage medium of the first apparatus of a subset of certificates recognized by the second apparatus, said subset comprising at least said nth encryption certificate.

According to another particular feature, the method furthermore comprises a second step of selection by the second apparatus of the nth encryption certificate, so that, the encryption certificate being associated with a secure communication channel generating procedure, this selection step determines the secure communication channel generating procedure to be used, each secure communication channel generating procedure being associated with a unique identifier.

According to a first embodiment, the first encryption key is a master key of S-MASTER type or of S-ENC type which is accompanied or not by a key of S-MAC type, according to the secure communication channel generating procedure used,

and in that the challenge included in the first encryption key consists of a first identifier associated with the secure communication channel generating procedure used.

According to a particular feature of the first embodiment, the method furthermore comprises, subsequent to the first step of encryption by the second apparatus with the first public key of the first encryption key, a third step of generation by the second apparatus of a first cryptogram according to a determined format, the first cryptogram comprising at least the first encrypted encryption key, the second step of transmission from the second apparatus to the first apparatus of the first encrypted encryption key consisting in transmitting the first cryptogram.

According to another particular feature of the first embodiment, the second step of generation by the first apparatus of a response to the challenge consists in generating a second identifier associated with the type of decrypted master key, the response to the challenge consisting of the second identifier.

According to another particular feature of the first embodiment, the method furthermore comprises:
a second step of encryption by the first apparatus with the first encryption key of the response to the challenge, before its transmission from the first apparatus to the second apparatus, and
a second step of decryption by the second apparatus with the first encryption key of the encrypted response, before its verification by the second apparatus,
   the third step of transmission from the first apparatus to the second apparatus at least of the response to the challenge consisting in transmitting at least the encrypted response to the challenge.

The method thus allows, even before the second step of verification by the second apparatus of the response to the challenge, that is to say before the end of the method according to the invention, an exchange secured by encryption/decryption of the data transferred from one apparatus to the other, as will be the subsequent exchanges related to the carrying out of at least one transaction.

According to another particular feature of the first embodiment, the second step of verification by the second apparatus of the response to the challenge consists of a first step of comparison between the first and second identifiers.

According to a second embodiment, the first step of generation by the second apparatus of the first encryption key comprises a first sub-step of generation by the second apparatus of a first random number and a second sub-step of generation of a second public key and of a second private key that are asymmetric and associated with the second apparatus, the first encryption key consisting of a first set formed by the first random number and the second public key, the second public key constituting said at least one part of the challenge and the second private key constituting the other part thereof.

According to a particular feature of the second embodiment, the method furthermore comprises, subsequent to the first step of encryption by the second apparatus with the first public key of the first encryption key, a third step of generation by the second apparatus of a second cryptogram according to a determined format, the second cryptogram comprising at least the first encrypted encryption key, the second step of transmission from the second apparatus to the first apparatus of the first encrypted encryption key consisting in transmitting the second cryptogram.

According to another particular feature of the second embodiment, the method furthermore comprises, after the first step of decryption by the first apparatus with said first private key of said first encrypted encryption key, a fourth step of generation by the first apparatus of a second random number, a concatenation of the first and second random numbers defining a second encryption key.

The method thus advantageously makes it possible to achieve a higher level of security in that the second encryption key, which will be used subsequently to encrypt/decrypt the exchanges between the first apparatus and the second apparatus, is generated in part by the first apparatus (according to the first embodiment, the first encryption key, which will be the one used subsequently to encrypt/decrypt the exchanges between the first apparatus and the second apparatus, is generated solely by the second apparatus).

According to another particular feature of the second embodiment, the second step of generation by the first apparatus of the response to the challenge consists of a second step of encryption by the first apparatus with the second public key of the second encryption key, the response to the challenge consisting of the second encrypted encryption key.

According to another particular feature of the second embodiment, the second step of verification by the second apparatus of the response to the challenge consists of a third step of decryption by the second apparatus with its second private key of the second encrypted encryption key and of a second step of comparison between the first random number arising from the third decryption step and the first random number generated during the first generation step.

According to another particular feature of the first and second embodiments, the response to the challenge furthermore comprises a formatted code representative of an acknowledgment of receipt by the first apparatus of the first encrypted encryption key, subsequent to its transmission from the second apparatus, the third step of transmission from the first apparatus to the second apparatus at least of the response to the challenge consisting in furthermore transmitting said formatted code.

According to another particular feature of the first and second embodiments, the second step of verification by the second apparatus of the response to the challenge furthermore consists in verifying that the formatted code is representative of the proper reception by the first apparatus of the first encrypted encryption key.

The method according to these last two particular features thus advantageously allows an additional verification independent of that related to the challenge submitted to the first apparatus by the second apparatus.

Other characteristics and advantages of the invention will emerge clearly from the description given thereof hereinafter, by way of wholly nonlimiting indication, with reference to the appended drawings, in which:

FIG. 1 schematically represents a biometric authentication method according to the prior art,

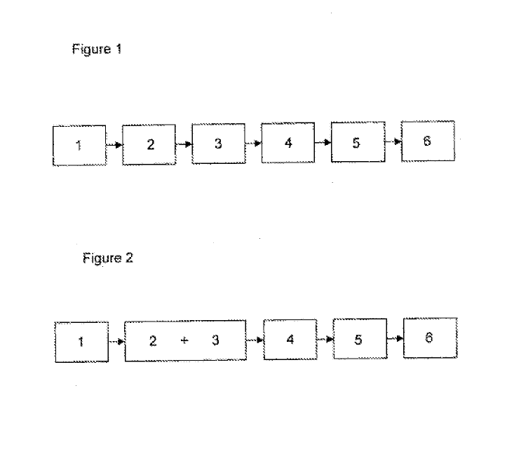

FIG. 2 schematically represents a biometric authentication method such as implemented with the method according to the invention,

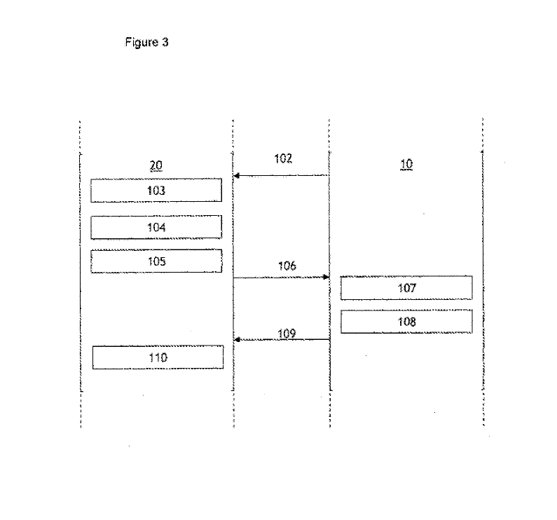

FIG. 3 schematically represents the method according to the invention,

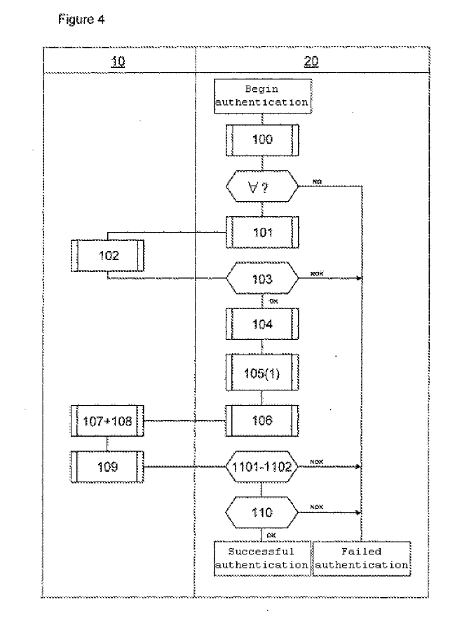

FIG. 4 schematically represents the method illustrated in FIG. 2 according to a first embodiment,

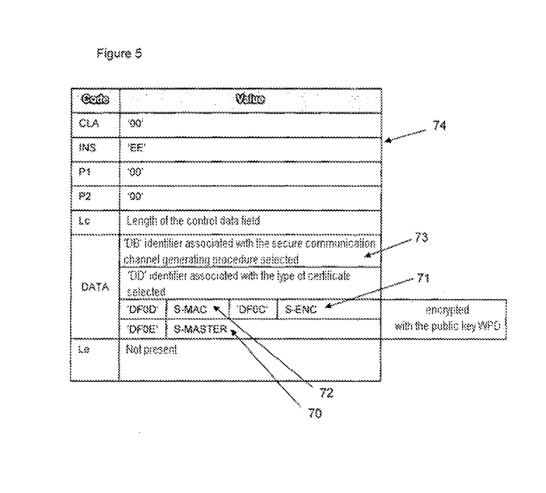

FIG. 5 illustrates a cryptogram according to the first embodiment of the method,

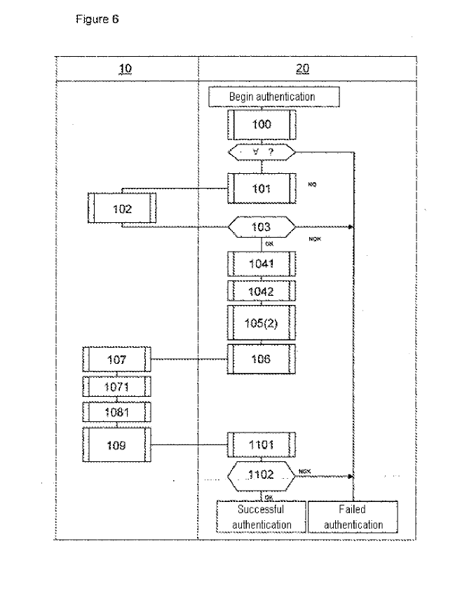

FIG. 6 schematically represents the method illustrated in FIG. 2 according to a second embodiment,

FIG. 7 illustrates a cryptogram according to the second embodiment of the method, and

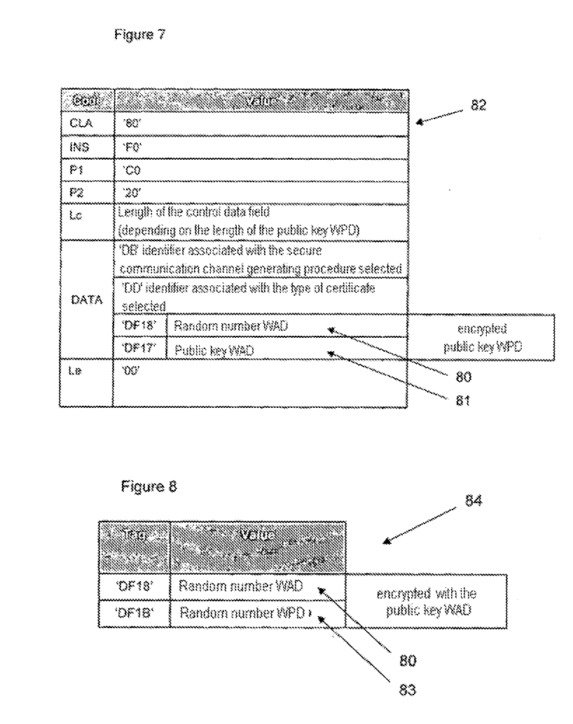

FIG. 8 illustrates the format of the response to the challenge according to the second embodiment of the method.

The authentication method implements a first communication apparatus 10 and a second communication apparatus 20. If only the authentication of the first apparatus by the second is considered subsequently, it is obvious that an authentication of the second apparatus by the first can be obtained, at the price of a simple reversal of their respective role in the present method.

The second apparatus is for example a local terminal. When it comprises inter alia wireless communication means, it more particularly constitutes a wireless acceptance device (or WAD). The second communication apparatus is used by a so-called acceptance user, such as a merchant, to carry out transactions of services, such as the sale/the purchase of merchandise or services, the withdrawing of money, payment by Internet, loyalty-related operations, physical access control, etc.

The second apparatus preferably comprises a set of components, which include:
a wireless personal network device (or Wireless Personal Area Network (WPAN)), which provides it with the capacity to communicate wirelessly,
a device for inputting verification data (or Verification Data Entry Device (VED)), which allows it to acquire individual (for example biometric) verification data of the user, and
software operating characteristics compatible with the first two components.

The second communication apparatus can also comprise a ‘Human-Machine Interface’ (HMI) to indicate the progress of the transactions to its user.

The wireless personal network device (WPAN) is a hardware component providing the second communication apparatus with a wireless personal network interface used to interconnect devices situated in a limited zone of coverage around the personal network device. The second communication apparatus uses the protocol of the personal network device to communicate, for example to exchange data or commands, with potentially a plurality of first communication apparatuses present in the zone of coverage of the personal network device.

The wireless personal network device is localized, but its location is not restricted. It may be onboard the second communication apparatus or be separated therefrom and connected in time as peripheral, for example by a link of USB type, to another device, for example a cash register of a point of sale.

The second portable apparatus is designed to communicate at least with a first communication apparatus.

The first communication apparatus is for example a wireless personal device (or WPD). It is carried and used by a user.

The second communication apparatus is in particular designed by virtue of its device for inputting verification data to capture and transmit to the first communication apparatus individual, for example biometric, data so that the first communication apparatus compares these data with a template that it stores so as to authenticate or not authenticate its user as legitimate owner. This step is illustrated in FIG. 1 and FIG. 2 by the numerical reference 4.

This example of biometric authentication of the user of the first portable apparatus illustrates that the first and second apparatuses are designed to carry out an applicative transaction between themselves in the course of what may appropriately be called a transactional session.

A transactional session more particularly comprises:
a step of initializing the session, which consists in initiating the communication between the second apparatus and at least one first apparatus,
an interaction step, in the course of which various value-added steps are carried out,
a step of closing the session, which closes the communication between the second apparatus and a first apparatus.

The transactional session model hereinabove applies whatever the mode of communication, for example with or without contact. The use of a particular mode of communication introduces peculiarities only during the step of initializing and the step of closing the session.

In a mode of contactless communication, the initializing step refers to the process of detection (cf. the reference 1 in FIG. 1 and FIG. 2) by the second apparatus of the plurality of first apparatuses present in the zone of coverage of the wireless personal network.

During a session, the interaction between the second communication apparatus and a first communication apparatus is carried out by use of exchanges of command and response messages initiated by the second apparatus. The commands (or Command-Automatic Data Processing Unit (C-ADPU)) and the responses (or Response-Automatic Data Processing Unit (ADPU)) are based for example on the ISO4 standard. The transfer of the commands from the second apparatus to a first apparatus and of the responses from a first apparatus to the second apparatus depends on the mode of communication.

The interaction step is carried out independently of the mode of communication used. It can comprise the selection of a personal access provider (or PAP), that provides services such as the authentication of the first apparatus (cf. the reference 2 in FIG. 1 and FIG. 2), the creation of a secure communication channel (cf. the reference 3 in FIG. 1 and FIG. 2) and the biometric authentication of the user (cf. the reference 4 in FIG. 1 and FIG. 2).

It is important to note that it is thus all the more advantageous to reduce the time necessarily taken by the interaction step because this step comprises steps of exchanges prior to any service transaction which are carried out for each first communication apparatus from among the plurality of first detected apparatuses.

The interaction step also consists of the execution of one or more service transactions (cf. the references 5 and 6 in FIG. 1 and FIG. 2). A service transaction is the execution of an application provided by a service provider. Several service transactions can be executed during one and the same transactional session, for example a payment transaction and a loyalty-related operation.

In particular to allow the authentication of the first communication apparatus by the second communication apparatus, at least one set of certificates is stored on a storage medium of the first apparatus, this set comprising at least one authentication and/or encryption certificate. From among this set of certificates, a subset of certificates is necessarily recognized by the second apparatus. In the converse case, the authentication of the first communication apparatus by the second communication apparatus cannot succeed; the authentication fails and the biometric authentication method is interrupted. As illustrated in FIG. 4 and FIG. 6, the second apparatus selects, during a first selection step 100, the subset of certificates that it recognizes from among said set. It is necessary with a view to authenticating the first apparatus that this subset comprise said at least one authentication and/or encryption certificate.

In the case where several encryption certificates are recognized by the second apparatus, the method envisages a second step of selection 101, illustrated in FIG. 4 and FIG. 6, by the second apparatus of a single encryption certificate, called the nth encryption certificate.

Each encryption certificate being associated with a secure communication channel generating procedure, this selection step 101, or equivalently the selection step 100 in the case where it culminates in the selection of a single recognized encryption certificate, determines the secure communication channel generating procedure to be used. Moreover, each secure communication channel generating procedure is associated with a unique identifier, so that the selected encryption certificate is indirectly associated with a unique identifier.

The nth encryption certificate stored on the storage medium of the first apparatus comprises at least one first public key associated with the first apparatus and a signature affixed by a certification authority that issued the encryption certificate. The storage medium of the first apparatus also stores a first private key associated asymmetrically with the first public key. It is apparent henceforth that the method relies essentially on two distinct parameters: an asymmetric encryption algorithm and a digital signature scheme.

As illustrated in FIG. 3, the method comprises:
a first step of transmission 102 from the first apparatus to the second apparatus of said nth encryption certificate,
a first step of verification 103 by the second apparatus of the signature of said nth encryption certificate,
a first step of generation 104 by the second apparatus of a first encryption key, the latter comprising at least one part of a challenge,
a first step of encryption 105 by the second apparatus with said first public key of the first encryption key,
a second step of transmission 106 from the second apparatus to the first apparatus of the first encrypted encryption key,
a first step of decryption 107 by the first apparatus with said first private key of said first encrypted encryption key,
a second step of generation 108 by the first apparatus of a response to the challenge,
a third step of transmission 109 from the first apparatus to the second apparatus at least of the response to the challenge, and
a second step of verification 110 by the second apparatus of the response to the challenge.

The method thus makes it possible to combine authentication of the first apparatus by the second apparatus and opening of a secure communication channel between the first apparatus and the second apparatus while appreciably reducing the number of exchanges required, and therefore the time required, with respect to a method in which the steps of authentication of the first apparatus by the second apparatus and of opening of a secure communication channel between the first apparatus and the second apparatus are carried out in a successive, distinct and independent manner. More particularly, only three so-called transmission steps are required for obtaining the desired result achieved. It should be noted, moreover, that the encryption key is transmitted from the second apparatus to the first apparatus in a secure manner, since, as it is encrypted with said public key of the first apparatus, only this latter can decrypt it with its private key.

Moreover, it should be noted that the first step of verification 103 by the second apparatus of the signature of said nth encryption certificate, if it does not return a positive result, gives rise to the failure of the authentication and the interruption of the biometric authentication method.

It should be understood that the first and second apparatuses comprise processing means for verifying, encrypting and/or decrypting.

The first step of verification 103 by the second apparatus of the signature of said nth encryption certificate is carried out using an associated verification algorithm used jointly with the public key of the corresponding certification authority and the corresponding digital signature scheme.

The method is realized more particularly as two embodiments which implement differently some of the steps of the method presented hereinabove. The two embodiments of the method will more particularly be described hereinbelow.

The first embodiment of the method is illustrated in FIG. 4 and FIG. 5.

According to the first embodiment of the method and as more particularly illustrated in FIG. 5, the first encryption key is a master key of S-MASTER type or of S-ENC type 71 according to the secure communication channel generating procedure used. This master key is accompanied or not by a key of S-MAC type according to the secure communication channel generating procedure used. The challenge included in the first encryption key consists of a first identifier associated with the secure communication channel generating procedure used.

According to the first embodiment, the method furthermore comprises, subsequent to the first step of encryption 105 by the second apparatus with the first public key of the first encryption key, a third step of generation 1051 by the second apparatus of a first cryptogram 74 according to a determined format. As illustrated in FIG. 6, the first cryptogram comprises at least the first encrypted encryption key 70, 71 or 72. The second step of transmission 106 from the second apparatus to the first apparatus of the first encrypted encryption key then consists in transmitting the first cryptogram.

According to the first embodiment, the second step of generation 108 by the first apparatus of a response to the challenge consists in generating a second identifier associated with the type of decrypted master key. The response to the challenge then consists precisely of the second identifier. Thus, during the selection step 100 or 101, the second apparatus has selected a certificate associated with an identifier, this identifier is included in the encryption key and is encrypted with the latter. Next, the first apparatus decrypts with its private key the first encryption key and recovers in particular said identifier. This identifier if it is decrypted with the first private key of the first apparatus that transmitted its encryption certificate must correspond to the identifier associated with the secure communication channel generating procedure defined in the encryption certificate. The challenge has thus been defined by the second apparatus on the basis of data specific to the secure communication channel generating procedure, and then submitted to the first apparatus which on the one hand is alone able to decrypt the response thereof and on the other hand knows a priori the ad hoc response to the challenge. It should be noted that independently the identifier 73 (cf. FIG. 6) of the secure communication channel generating procedure used can be written in an unencrypted manner in the first cryptogram.

According to the first embodiment, the method furthermore comprises:
a second step of encryption by the first apparatus with the first encryption key of the response to the challenge, before its transmission from the first apparatus to the second apparatus, and
a second step of decryption by the second apparatus with the first encryption key of the encrypted response, before its verification by the second apparatus. The third step of transmission 109 from the first apparatus to the second apparatus of the response to the challenge then consists in transmitting at least the encrypted response to the challenge.

According to the first embodiment, the method therefore advantageously envisages, even before the second step of verification by the second apparatus of the response to the challenge, an exchange secured by encryption/decryption of the data transferred from one apparatus to the other, such as will be the subsequent exchanges related to the carrying out of at least one service transaction.

According to the first embodiment, the second step of verification 110 by the second apparatus of the response to the challenge consists of a first step of comparison between the first and second identifiers. The second verification step 110, if it does not return a positive result, gives rise to the failure of the authentication and the interruption of the biometric authentication method; conversely, if it returns a positive result, it gives rise to the success of the authentication and the possibility of continuing the biometric authentication method, for example by a step of biometric authentication of the user of the first apparatus.

The second embodiment of the method is illustrated by FIG. 6, FIG. 7 and FIG. 8.

According to the second embodiment and as illustrated in FIG. 6, the first step of generation 104 by the second apparatus of the first encryption key comprises a first sub-step of generation 1041 by the second apparatus of a first random number 80 and a second sub-step of generation 1042 of a second public key 81 and of a second private key that are asymmetric and associated with the second apparatus. The first encryption key consists of a first set formed by the first random number and the second public key. The second public key constitutes said at least one part of the challenge and the second private key constitutes the other part thereof.

According to the second embodiment, the method furthermore comprises, subsequent to the first step of encryption 105 by the second apparatus with the first public key of the first encryption key, a third step of generation 1052 by the second apparatus of a second cryptogram 82 according to a determined format. As illustrated in FIG. 7, the second cryptogram comprises at least the first encrypted encryption key. The second step of transmission 106 from the second apparatus to the first apparatus of the first encrypted encryption key then consists in transmitting the second cryptogram.

According to the second embodiment and as illustrated in FIG. 6, the method furthermore comprises, after the first step of decryption 107 by the first apparatus with said first private key of said first encrypted encryption key, a fourth step of generation 1071 by the first apparatus of a second random number 83 (cf. FIG. 8), a concatenation of the first and second random numbers defining a second encryption key.

According to its second embodiment, the method thus advantageously makes it possible to achieve a higher level of security in that the second encryption key, which will be that used subsequently to encrypt/decrypt the exchanges between the first apparatus and the second apparatus, is generated in part by the first apparatus. Conversely, according to the first embodiment, the first encryption key, which will be that used subsequently to encrypt/decrypt the exchanges between the first apparatus and the second apparatus, is generated solely by the second apparatus.

According to the second embodiment, the second step of generation 108 by the first apparatus of the response to the challenge consists of a second step of encryption 1081 by the first apparatus with the second public key of the second encryption key. As illustrated in FIG. 8, the response to the challenge 84 then consists of the second encrypted encryption key.

According to the second embodiment and as illustrated in FIG. 6, the second step of verification 110 by the second apparatus of the response to the challenge consists of a third step of decryption 1101 by the second apparatus with its second private key of the second encrypted encryption key and in a second step of comparison 1102 between the first random number arising from the third decryption step and the first random number generated during the first generation step 104.

As illustrated in FIG. 5 and FIG. 7, the first cryptogram 74 and the second cryptogram 82 furthermore comprise several fields, which include a field for advising a class (CLA), a field for advising a first parameter (P1), a field for advising a second parameter (P2), a field for advising a length of the control data field (L), and a field for advising an identifier of the set of selected certificates recognized by the second apparatus.

According to the first embodiment and the second embodiment, the response to the challenge furthermore comprises a formatted code representative of an acknowledgment of receipt by the first apparatus of the first encrypted encryption key, subsequent to its transmission from the second apparatus. The third step of transmission 109 from the first apparatus to the second apparatus at least of the response to the challenge then consists in furthermore transmitting said formatted code.

Consequently, the second step of verification 110 by the second apparatus of the response to the challenge furthermore consists in verifying that the formatted code is representative of the proper reception by the first apparatus of the first encrypted encryption key.

It should be obvious to the those versed in the art that the present invention allows embodiments in numerous other specific forms without straying from the as-claimed domain of application of the invention. Consequently, the present embodiments should be considered by way of illustration but may be modified within the domain defined by the scope of the appended claims.

1. A method for authenticating a first communication apparatus by a second communication apparatus, the first apparatus comprising at least one storage medium suitable for storing at least:
an nth encryption certificate comprising a first public key associated with the first apparatus and a signature affixed by a certification authority that issued the encryption certificate, and
a first private key associated asymmetrically with the first public key, the nth encryption certificate being recognized by the second apparatus, the method being wherein the method comprises:
a first step of transmission from the first apparatus to the second apparatus of said nth encryption certificate,
a first step of verification by the second apparatus of the signature of said nth encryption certificate,
a first step of generation by the second apparatus of a first encryption key, the latter comprising at least one part of a challenge,
a first step of encryption by the second apparatus with said first public key of the first encryption key,
a second step of transmission from the second apparatus to the first apparatus of the first encrypted encryption key,
a first step of decryption by the first apparatus with said first private key of said first encrypted encryption key,
a second step of generation by the first apparatus of a response to the challenge,
a third step of transmission from the first apparatus to the second apparatus at least of the response to the challenge, and
a second step of verification by the second apparatus of the response to the challenge.

2. The authentication method as claimed in claim 1, further comprising, prior to the first step of transmission from the first apparatus to the second apparatus of said nth encryption certificate, a first step of selection by the second apparatus from among a set of certificates stored on the storage medium of the first apparatus of a subset of certificates recognized by the second apparatus, said subset comprising at least said nth encryption certificate.

3. The authentication method as claimed in claim 2, wherein the method furthermore comprises a second step of selection by the second apparatus of the nth encryption certificate, so that, the encryption certificate being associated with a secure communication channel generating procedure, this selection step determines the secure communication channel generating procedure to be used, each secure communication channel generating procedure being associated with a unique identifier.

4. The authentication method as claimed in claim 1, wherein the first encryption key is a master key of S-MASTER type or of S-ENC type which is accompanied or not by a key of S-MAC type, according to the secure communication channel generating procedure used, and in that the challenge included in the first encryption key comprises a first identifier associated with the secure communication channel generating procedure used.

5. The authentication method as claimed in claim 4, further comprising, subsequent to the first step of encryption by the second apparatus with the first public key of the first encryption key, a third step of generation by the second apparatus of a first cryptogram according to a determined format, the first cryptogram comprising at least the first encrypted encryption key, the second step of transmission from the second apparatus to the first apparatus of the first encrypted encryption key comprising transmitting the first cryptogram.

6. The authentication method as claimed in claim 4, wherein the second step of generation by the first apparatus of a response to the challenge comprises generating a second identifier associated with the type of decrypted master key, the response to the challenge comprising the second identifier.

7. The authentication method as claimed in claim 6, wherein it furthermore comprises:
a second step of encryption by the first apparatus with the first encryption key of the response to the challenge, before its transmission from the first apparatus to the second apparatus, and
a second step of decryption by the second apparatus with the first encryption key of the encrypted response, before its verification by the second apparatus, the third step of transmission from the first apparatus to the second apparatus at least of the response to the challenge comprising transmitting at least the encrypted response to the challenge.

8. The authentication method as claimed in claim 6, wherein the second step of verification by the second apparatus of the response to the challenge comprises a first step of comparison between the first and second identifiers.

9. The authentication method as claimed in claim 1, wherein the first step of generation by the second apparatus of the first encryption key comprises a first sub-step of generation by the second apparatus of a first random number and a second sub-step of generation of a second public key and of a second private key that are asymmetric and associated with the second apparatus, the first encryption key comprising a first set formed by the first random number and the second public key, the second public key constituting said at least one part of the challenge and the second private key constituting the other part thereof.

10. The authentication method as claimed in claim 9, wherein it furthermore comprises, subsequent to the first step of encryption by the second apparatus with the first public key of the first encryption key, a third step of generation by the second apparatus of a second cryptogram according to a determined format, the second cryptogram comprising at least the first encrypted encryption key, the second step of transmission from the second apparatus to the first apparatus of the first encrypted encryption key comprising transmitting the second cryptogram.

11. The authentication method as claimed in claim 9, wherein it furthermore comprises, after the first step of decryption by the first apparatus with said first private key of said first encrypted encryption key, a fourth step of generation by the first apparatus of a second random number, a concatenation of the first and second random numbers defining a second encryption key.

12. The authentication method as claimed in claim 11, wherein the second step of generation by the first apparatus of the response to the challenge comprises a second step of encryption by the first apparatus with the second public key of the second encryption key, the response to the challenge comprising the second encrypted encryption key.

13. The authentication method as claimed in claim 12, wherein the second step of verification by the second apparatus of the response to the challenge comprises a third step of decryption by the second apparatus with its second private key of the second encrypted encryption key and of a second step of comparison between the first random number arising from the third decryption step and the first random number generated during the first generation step.

14. The authentication method as claimed in claim 6, wherein the response to the challenge furthermore comprises a formatted code representative of an acknowledgment of receipt by the first apparatus of the first encrypted encryption key, subsequent to its transmission from the second apparatus, the third step of transmission from the first apparatus to the second apparatus at least of the response to the challenge comprising furthermore transmitting said formatted code.

15. The authentication method as claimed in claim 8, wherein the second step of verification by the second apparatus of the response to the challenge furthermore comprises verifying that the formatted code is representative of the proper reception by the first apparatus of the first encrypted encryption key.
